(19) United States
(12) Patent Application Publication
(10) Pub. No.: US 2013/0018667 A1
(43) Pub. Date: Jan. 17, 2013

(54) Measuring Outcomes Via Telephony

(71) Applicant: Geoffrey Howard Nudd, San Francisco, CA (US)

(72) Inventor: Geoffrey Howard Nudd, San Francisco, CA (US)

(73) Assignee: ClearCare, Inc., San Francisco, CA (US)

(21) Appl. No.: 13/293,039

(22) Filed: Nov. 9, 2011

Related U.S. Application Data
(63) Continuation-in-part of application No. 13/180,447, filed on Jul. 11, 2011.

(51) Int. Cl. G06Q 50/22

(52) U.S. Cl. 705/2

(57) ABSTRACT

A telephony accessible calendar system is provided for use in a home care scheduling system for scheduling multiple daily work shifts of home care providers that includes a scheduling to organize work shifts of remote operating home care workers and confirmation to obtain an electronic signature from one or more persons operating as individual signers near the end of a work shift, and the tracking of status and/or change in status of one or more measured outcomes associated with the work shift.

### RELATED APPLICATIONS

This application is a continuation-in-part of U.S. Non-Provisional patent application Ser. No. 13/180,447, entitled “Updating a Calendar or Task Status Via Telephony,” filed Jul. 11, 2011.

### BACKGROUND

The invention relates to a computer-enabled approach for measuring clinical outcomes remotely via a mobile tablet or telephony.

Computer-enabled calendar systems date to the early days of software. In the 1990s and thereafter, a growing number of online calendar systems have been introduced which enable a user to, among other functions, create new events and tasks, schedule with other users, and send and receive reminders. Many of these calendars are now available online, such as that provided by Google Calendar, wherein they allow access across geographies and via any Internet-enabled terminal.

U.S. patent application Ser. No. 13/180,447 addresses existing online calendar systems in their management of “tasks”, which may be defined as an assignment of work to-be-completed with an assigned date on which the work is to be completed and/or started and/or in-progress, and at least one complete or incomplete state. As defined herein, tasks are a superset which contains “events” which are typically meetings or scheduled occurrences in which the work to-be-completed primarily or exclusively involves attendance or participation in the event itself (i.e. a meeting). An important differentiator between events and tasks which are not events, which are often referred to as “to do's” and which we shall call “non-event tasks”, is that non-event tasks lend themselves to tracking via checklists, a well-known and remarkably effective and simple way to track outstanding and completed tasks, wherein it is generally not effective or useful to track events via checklists (i.e. a checklist of outstanding and/or completed meetings).

U.S. patent application Ser. No. 13/180,447 addressed shortcomings in of existing online calendar systems such as Google Calendar, Yahoo Calendar and others have built rich functional capabilities for the management of events such as the ability to create recurring series of events (for example, a meeting that occurs every Monday at 10:00 AM) or the ability to send invitations to a variety of attendees, but have not introduced similar capabilities for the management of non-event tasks. Conversely, existing calendar systems had introduced functionality such as checklists for non-event tasks which have not been created for events. This introduced a significant shortcoming, particularly in the creation of work management systems that provide the ease of use and flexibility of a calendar interface with the work tracking capabilities of checklists. U.S. patent application Ser. No. 13/180,447 disclosed an online calendar system which enables the ability to create recurring non-event tasks in a computer-enabled system with a checklist interface that allows a user to mark the status of a task (including but not limited to marking the status of a task as complete). Such a system can now be found in use by companies such as ClearCare, Inc. (www.clearcareonline.com) for scheduling and tracking and management of work performed by remote workers.

U.S. patent application Ser. No. 13/180,447 and systems such as that provided by ClearCare, Inc. provide for an online system enabling the creation of recurring non-event tasks in a calendar system and managing their completion via a checklist interface

U.S. patent application Ser. No. 13/180,447 and ClearCare Inc. provide for a calendar system with task-level specificity and means of tracking the performance of said tasks via telephony or tablet.

By way of example and without limitation, in the in-home health care industry, solutions like ClearCare are used to track clock-in and clock-out times relative to shifts using telephony to update the clock-in or clock-out status of a remote caregiver, and furthermore enable the detailed tasks that comprise a care plan to be updated via the remote telephony system. There are complex challenges associated with enabling such a system, such as text-to-voice automated translation of tasks in a care plan, which ClearCare solves.

However, there remains a shortcoming need in that the existing art for scheduling and tracking remote tasks is generally binary in nature, as provided for by reporting of “yes” or “no” status, and/or is free form in nature with the capability to record open-ended text or voice comments.

Overcoming this could significantly improve the lives of millions of people. For example, considering without limitation the in-home care industry, while individual tasks can be tracked as complete or incomplete such as “serve dinner” or “take for short walk,” the corresponding changes in underlying capability such as “appetite” or “ambulation” cannot be easily determined or quantified. So if “prepare dinner” is tracked as either complete or not complete, the perhaps more important underlying metric for “appetite” remains indeterminate. Similarly, if “take for short walk” is tracked as either complete or not complete, the perhaps more important underlying metric for “ambulation” remains indeterminate. Free form text or voice comments may provide important information on the underlying metrics, but the disadvantage of free form text or voice comments is that they do not lend themselves to automated alert systems to elevate important changes in said underlying metrics to one or more persons with monitoring responsibility.

In the case of the management of in-home care, the inability to adequately communicate with people receiving home care could create problems for millions of people. By way of example, an elderly person may have a rapidly deteriorating condition, such as difficulty walking, as a result of a change in medication or other cause. This problem may not be discovered by a home care administrator, family member, or qualified medical person for several weeks because ambulation is not being measured in the home at the point of care, and the changes not properly reported by a relatively untrained in-home caregiver. By the time the deterioration is discovered, the person is no longer able to walk and the muscles have deteriorated. At this point, full recovery is often impossible.

These unmet needs of the existing art leads to limited transparency and control over the care plan and condition of the person receiving care to stakeholders such as in-home care managers, healthcare providers, and the family members of a patient or client. Moreover, in the example of the in-home care industry, these shortcomings today are addressed via mechanisms like paper care journals which reside in the home of the patient and which are periodically updated by caregivers. The paper care journals are often overlooked by caregivers and the in-home care managers and the families of the patients have no visibility to the care provided and the tasks performed. This industry example illustrates the very significant and important problems with the existing art, and the quality of care can be significantly improved by solving these problems.

Thus, what is needed is an approach to addressing these shortcomings and of work management systems with ease of use, flexibility, and cost-effective accessibility in a plurality of locations, and which enables tracking of measured outcomes and/or changes in outcomes. As will be seen, the invention provides such an approach in an elegant manner.

### BRIEF DESCRIPTION OF THE DRAWINGS

Various preferred embodiments of the present invention are illustrated by way of example, and not by way of limitation, in the figures of the accompanying drawing and in which like reference numerals refer to similar elements and in which:

FIG. 1 is a wireframe diagram that illustrates an interface of a web-based portal for a work management system which provides tracking and management of work, a photo storage service which allows the automatic display of photos which are uploaded via said web-based portal to a digital picture frame, the creation and management of non-event tasks, the updating of the status of non-event tasks via a computer interface and/or telephony, and the reporting of measured outcomes via a computer interface and/or telephony.

FIG. 2 is a wireframe diagram that illustrates the task and reportable measured outcome information request calendar interface of a web-based portal for a work management system which provides tracking and management of work, a photo storage service which allows the automatic display of photos which are uploaded via said web-based portal to a digital picture frame, the creation and management of non-event tasks, updating of the status of non-event tasks via a checklist interface and/or telephony, and the reporting of measured outcomes via a checklist interface and/or telephony.

FIG. 3 is a wireframe diagram that illustrates shift and task details and measured outcome details portion of a task and measured outcomes information calendar interface of a web-based portal for a work management system which provides tracking and management of work, tracking and measurement of outcomes, a photo storage service which allows the automatic display of photos which are uploaded via said web-based portal to a digital picture frame, the creation and management of non-event tasks, the creation and management of information requests for measured outcomes, the updating of the status of non-event tasks via a computer interface and/or telephony, and the reporting of measured outcomes via a computer interface and/or telephony.

FIG. 4 and FIG. 5 are wireframe diagrams that illustrate interfaces for caregivers and their patients which are part of the healthcare information system described herein, and which are preferably displayed on a touch screen tablet (by way of example, an Apple iPad) which is used by a caregiver to manage and document care tasks, report on measured outcomes, and which also functions as a digital picture frame when not in use by the caregiver or other users.

FIG. 6 is a flow diagram that illustrates a process by which the status of specific task information or measured outcome information is updated via telephony using computer-enabled text-to-voice conversion and in which verification information is obtained.

FIG. 7 is a block diagram that illustrates the communication of entities via Internet connections for the transmission of a variety of information.

FIG. 8 is an illustrative report of measured outcome data.

### DETAILED DESCRIPTION

This patent application incorporates by reference U.S. provisional patent application No. 61/394,676, “System and Apparatus for Automatically Displaying Photos Remotely Uploaded to a Digital Picture Frame,” filed on Oct. 19, 2010 and U.S. patent application Ser. No. 13/277,146, filed Oct. 19, 2011.

In one view, the invention is directed to a telephony accessible calendar system for use in a home care scheduling system for scheduling multiple daily work shifts of home care providers wherein information on certain measured outcomes is requested of the home care providers. In one embodiment, a calendaring system includes a scheduling system configured to organize work shifts of remote operating home care workers and a confirmation module configured to obtain an electronic signature from one or more persons operating as individual signers near the end of a work shift.

In one embodiment, an apparatus and computer-enabled system implemented by software is provided for the creation of non-event tasks in a calendar system wherein the entry of a single non-event task and/or one or more measured outcome information requests can be made recurring on a daily, weekly, or monthly basis according to parameters set by the user; and/or wherein the one or more non-event tasks and/or measured outcomes may be grouped relative to a recurring shift, and/or wherein the non-event task and/or measured outcome information request may be assigned to one or more persons or groups of persons for completion; and/or wherein the completion status of one or more non-event tasks and/or the status and/or change in status of a measured outcome may be updated via a computer-enabled terminal connected to the Internet and/or telephony system; and/or wherein one or more users at remote locations may view the updated completion status of the one or more non-event tasks; and/or wherein an exception state may be noted relative to the completion of one or more non-event tasks and a reason provided by the assigned person(s); and/or wherein the completion status of the one or more non-event tasks is managed by a checklist interface; and/or wherein the status and/or change in status information of one or more measured outcomes is viewable via a computer interface.

In another embodiment, the aforementioned calendar systems may be interfaced with via a telephony system and/or via a computer connected to the Internet wherein the telephony system allows the person(s) assigned to a non-event task and/or to the measured outcome information request to update the completion status of the non-event task and/or the status or change in status of one or more measured outcomes. In one embodiment, the computer-enabled system uses automated text-to-voice technology such as that enabled by commercial providers such as Twilio (www.twilio.com) accessed via an application programming interfaced (API) in conjunction with software code known by those skilled in the art to read instructions or other parameters of one or more non-event tasks and/or measured outcome information requests to the person(s) assigned. In another embodiment, the computer-enabled system accepts input via telephone from the person(s) assigned by which the person(s) updates the status of the non-event task and/or the status of the one or more measured outcomes and/or the change in status of the one or more measured outcomes. By way of example, by pressing the number “one” on the telephone after the computer-enabled system reads the instructions and/or title for the non-event task, the person(s) assigned marks the task complete. By way of example, by pressing “one” on the telephone after the computer-enabled systems reads the type of measure outcome such as “ambulation”, the person(s) assigned marks ambulation as “better” than yesterday from a menu of “better,” “same”, or “worse. In another embodiment, if the person(s) assigned notes an exception to the expected status of the non-event task such as updating the status as “incomplete,” then the person may communicate a voice message which is associated with the task and/or group of tasks which communicates additional information which may include, by way of example, the reason that the non-event task was not completed. In another embodiment, if the person(s) assigned notes an exception to the expected and/or desired status or the change of status of a measured outcome such as updating the change in status as “worse” than yesterday, then the person may communicate a voice message which is associated with the task and/or group of tasks which communicates additional information which may include, by way of example, additional information related to the measured outcome or change in measured outcome.

In another embodiment, an algorithm may be used to determine whether the person(s) assigned to report on a measured outcome is automatically prompted to communicate said additional information. By way of example, the algorithm may automatically prompt for additional information if the change in a measured outcome is reported as “worse” for two days in a row, or for two days within the same week. By way of example, the algorithm may use quantitative scoring of changes in the measured outcome, such as scoring each outcome of “worse” as a −1, “same” as a 0, and “better” as a “+1”, and triggering the prompt for additional information if the sum of scores within the past seven days is −2 or below.

In another embodiment, the voice message is stored in a system accessible via the Internet by which the status of one or more tasks (the “checklist”) may be viewed by one or more users. In another embodiment, a transcript of the voice message is recorded and displayed next to the relevant non-event task or group of tasks. In another embodiment, the transcript of the voice message is created via automated computer-enabled voice-to-text translation as enabled by commercial providers such as Twilio, accessed via API in conjunction with other software code, the implementation of which can be performed by those skilled in the art.

In another embodiment, the aforementioned telephony-accessible calendar system provides the capability of obtaining an electronic signature from one or more persons at the end of a work shift. In one embodiment, said system uses text to voice technology to read information about the shift to said one or more persons, wherein information may include but is not limited to the clock in time and/or the non-event task completion status, and/or the status or change in status of measured outcome information, and the said one or more persons is prompted to provide an electronic signature to verify the information about the shift. In one embodiment, the electronic signature is provided via a confidential personal identification number (“PIN”) that is known only to the person asked to provide verification. In another embodiment, the electronic signature is provided via a voice recording that the signer leaves via a telephone after listening to the aforementioned information about the shift. In another embodiment, the PIN is used in conjunction with the voice recording to comprise a fraud- and falsification-resistant electronic signature.

In another embodiment, an indicator of the electronic signature is provided in an electronic log accessible via website in association with related information about the shift. In another embodiment, a link to a copy of the voice-recorded signature is provided in an electronic log accessible via website in association with related information about the shift.

In another embodiment, the aforementioned telephony-accessible calendar system is used as part of a work management system for the management of a remote workforce.

In another embodiment, the aforementioned telephony-accessible calendar system is used as part of a work management system for in-home care agencies enabling the management of caregivers working remotely in the homes of patients and/or clients to provide care.

In another embodiment, the telephony system verifies the location of the remote worker at the time the status of a non-event task is recorded by comparing the caller ID of the telephone from which the remote worker is calling to a database of known telephone numbers and locations.

In another embodiment, the work management system automatically generates an alert which is communicated to one or more users in the event that a non-event task is not completed as expected per parameters designated by one or more users.

In another embodiment, the work management system automatically generates an alert which is communicated to one or more users in the event that the status of a measured outcome, or the change in status of a measured outcome, meets certain criteria.

In the following description, for the purposes of explanation, specific details are set forth in order to provide a thorough understanding of the present invention. However, it will be apparent that the present invention may be practiced without these specific details. In other instances, well-known structures and devices are depicted in block diagram form in order to avoid unnecessarily obscuring the present invention.

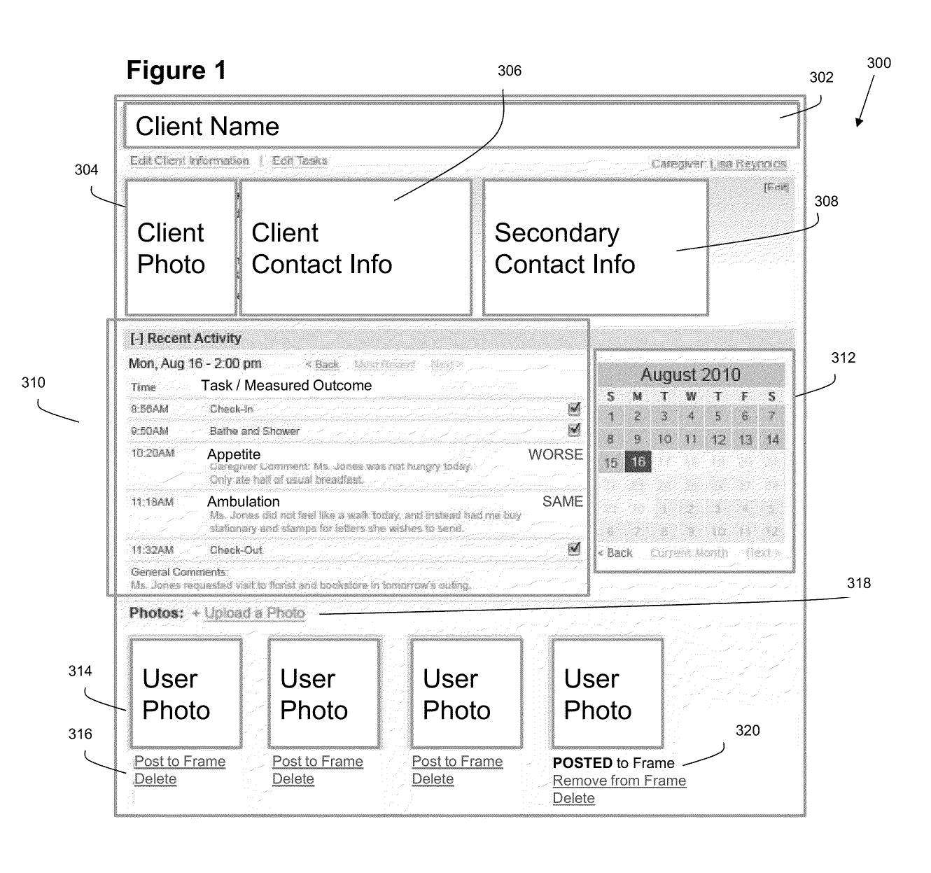

FIG. 1 is a wireframe diagram that illustrates an interface of a web-based portal for a work management system which provides tracking and management of work, a photo storage service which allows the automatic display of photos which are uploaded via said web-based portal to a digital picture frame, the creation and management of non-event tasks, the updating of the status of non-event tasks via a checklist interface and/or telephony, and the reporting of measured outcomes via a checklist interface and/or telephony.

In one embodiment, a touch screen tablet functioning as a digital picture frame and connected to the Internet, such as an Apple iPad, functions as a device by which one or more work providers manages and documents tasks at the client point-of-service.

Element 302 illustrates a field by which identifying information of a client is displayed. Element 304 illustrates a field by which a photo of the client is displayed. Elements 306 and 308 illustrate fields by which contact information of the client is displayed. The reader may imagine that a variety of user or user group profile information may be displayed.

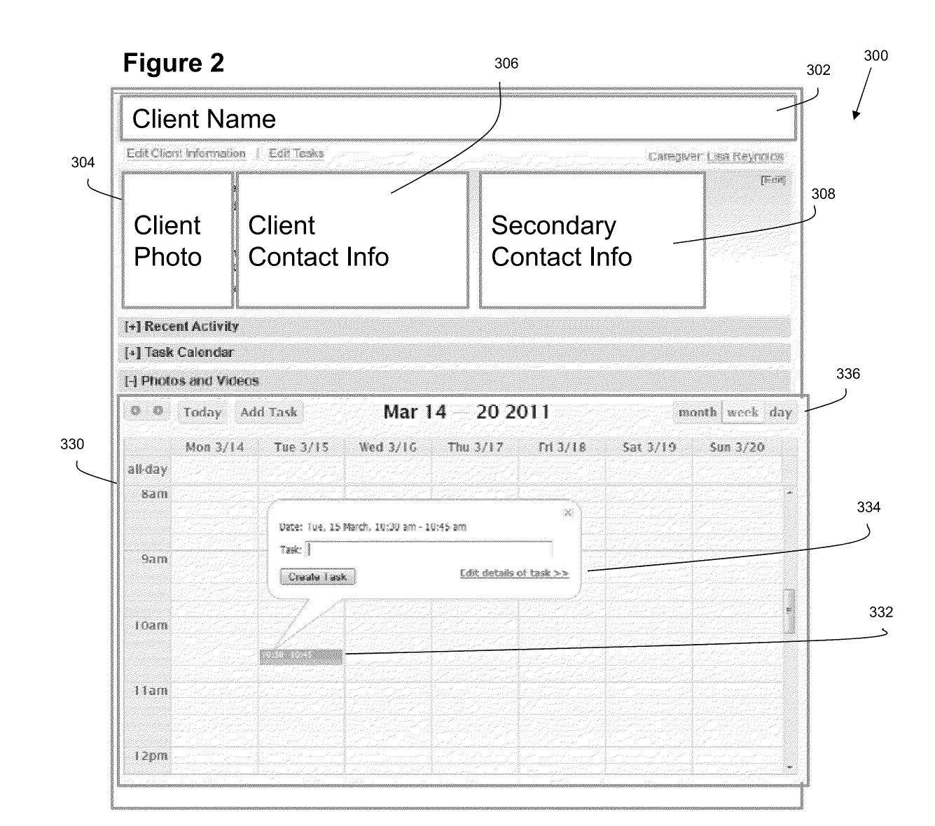

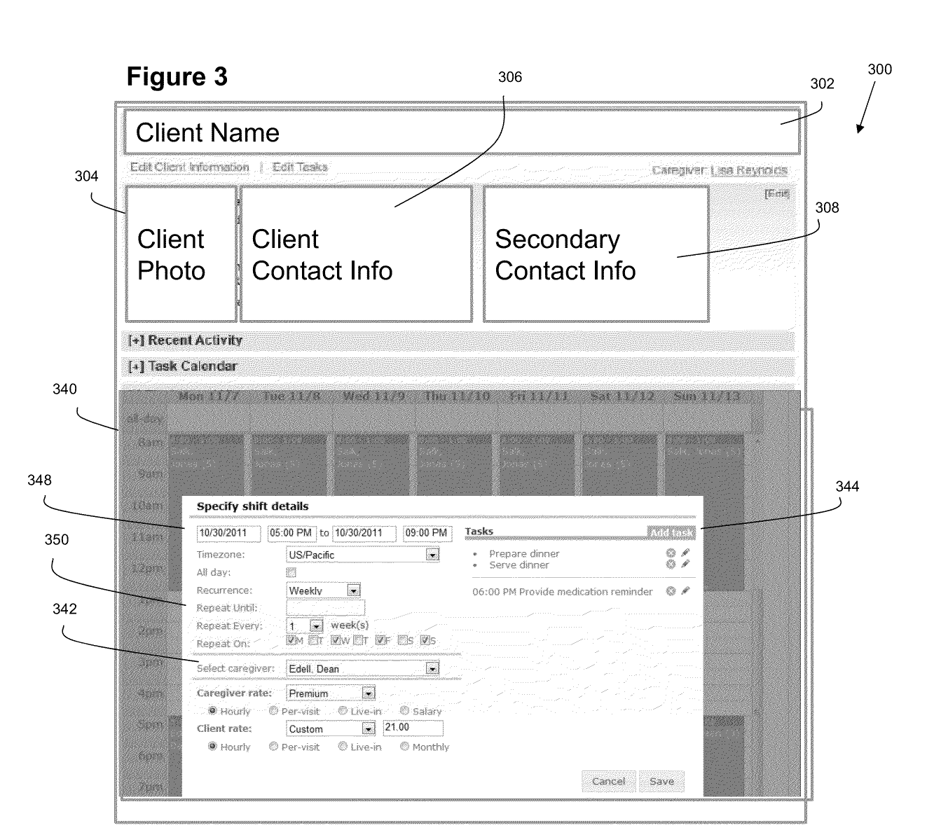

Elements 310 and 312 allow an integrated work management system to perform a variety of functions which may include but are not limited to: (1) tracking the completion and status of non-event tasks, (2) tracking the status and/or metrics and/or change in metrics of measured outcomes such as, by way of example, ambulation, appetite, or memory (3) enabling work providers to provide input to said work management system via a separate interface (see FIG. 2 and FIG. 3) and/or via telephony as will be described, and/or (4) allows the client or family of the client to view tasks which have been completed by a work provider.

In one embodiment, any user of the web portal 300 must be authenticated before being able to view the web portal 300 in order to protect the confidential and private information of the client. Means of authentication are well-known to those skilled in the art and include but are not limited to password protection and/or use of a personal identification number (PIN).

Element 310 illustrates a list of non-event tasks (“checklist”) and/or measured outcomes. In one embodiment, the list provides status information for each task which may include but is not limited to a variety of states such as to-be-completed, complete, incomplete, or exception. In one embodiment, the list provides status information for each measured outcome which may include but is not limited to a variety of states and/or change in states such as better, same, worse, and/or a measurement such as, by way of example, “4 mmol/L” for a measurement of blood glucose for a person with diabetes. As shown in the present example, the task and/or measured outcome list 310 includes a variety of information for each task and/or measured outcome, including but not limited to the time at which a work provider completed a task and/or measurement of a measured outcome and/or made an input relative to the task and/or measured outcome, a description of the task and/or measured outcome, comments submitted by the work provider, and whether or not the task was completed and/or the measured outcome was measured and/or observed. Element 312 illustrates a calendar input interface which when a day is clicked queries the set of non-event tasks and/or measured outcomes related to that day, including completed and incomplete tasks and/or measured outcomes, and tasks and/or measured outcomes which are planned for completion and/or observation in the future, and in one embodiment displays said tasks and/or measured outcomes in a task list 310.

In one embodiment, a work provider logs-in to the system from the point-of-service of the client, sees the non-event tasks which are to be completed and/or measured outcomes which are to be measured and/or observed, and marks tasks as complete and/or incomplete and/or marks measured outcomes as better, same, and/or worse and/or takes measurements relative to the measured outcomes, and/or enters comments relative to the aforementioned. In one embodiment, said comments and completion inputs from the work provider are transmitted via the Internet to the work management system, and the completion information about the tasks and/or the measured outcomes and/or the comments are shown in element 310 when one of a variety of authorized users, such as a manager or administrator, the work provider, the client, or the family or colleagues of the client view the web portal 300. The provided herein are embodiments having multiple benefits including transparency of work performed and to the person's condition relative to the measured outcomes to the aforementioned parties.

This transparency has tremendous value to potentially millions of people receiving in-home care from a remote caregiver. By way of example, the problem exists today that an elderly person may have a rapidly deteriorating condition, such as difficulty walking, as a result of a change in medication or other cause. This problem may not be discovered by a home care administrator, family member, or qualified medical person for several weeks because ambulation is not being measured in the home at the point of care, and/or the deterioration not properly reported by the caregiver. By the time it is discovered, the person is no longer able to walk and the muscles have deteriorated. At this point, full recovery is often impossible. By capturing status of measured outcomes or change in measured outcomes, alerts can be generated that alert the home care administrator, family member, qualified medical person, or other persons of the condition or change in condition such that said person(s) are alerted to the problem early and can intervene in time for such change to be effective.

Element 318 illustrates a link to “Upload a Photo” which directs to a web-enabled interface which features an input field, a “Browse” button to find photo files on a local system, and an “Upload” button. Via these buttons and associated features, a photo file may be selected and uploaded to the work management system and thereby displayed in element 314 and stored. Systems and methods for uploading a photo file over the Internet are well known to those skilled in the art. The photo 314 may thereby be subsequently displayed by the system serving as a point of service input device for work providers, which thus in a preferred embodiment also serves as a digital picture frame.

Via this interface, family members, friends, or other persons authorized by the client and/or work provider are able to both monitor work and upload photos 314 for display on the digital picture frame, which displays the photos 314 when said frame is not in use by the work provider for the provision and tracking of work (see FIG. 2 and FIG. 3). Element 316 is a pair of hyperlinks to “Post to Frame” or “Delete”, which respectively trigger functions to designate the photo 314 for download by the digital picture frame, or to delete the photo 314 from the work management system. The links illustrated in element 316 are displayed when a photo 314 is displayed on the work management system, but which have not been designated for download by the digital picture frame.

Element 320 illustrates the text, hyperlinks and features which are preferably displayed and enabled, respectively, when a photo 314 has been designated for display in the digital picture frame. The words “POSTED to Frame” indicate that the photo 314 has been designated for display in the digital picture frame. The “Remove from Frame” hyperlink allows the user to remove the designation that the photo 314 is to be displayed in the digital picture frame. The “Delete” hyperlink in element 316 allows the user to delete the photo 314 entirely from the work management system, and thereby to also delete the photo 314 from the digital picture frame.

FIG. 2 is a wireframe diagram that illustrates and example of the task and reportable measured outcome information request calendar interface 330 of a web-based portal 300 for a work management system which provides tracking and management of work, a photo storage service which allows the automatic display of photos which are uploaded via said web-based portal to a digital picture frame, the creation and management of non-event tasks, updating of the status of non-event tasks via a checklist interface and/or telephony, and the reporting of measured outcomes via a checklist interface and/or telephony.

In one embodiment, the task and measured outcome request input calendar interface 330 is readily accessible and adjacent to the client-specific interface with elements 302, 304, 306 and/or 308, and/or the interface related to task and measured outcome status 310, and/or the interface related to digital photo functionality containing elements 314, 316, 318 and/or 320.

In task input and measured outcome request calendar interface 330, a user may create a new work task or request the reporting of status and/or change in status relative to a measured outcome by clicking any time on the calendar and/or by clicking an “Add Task” button. In one embodiment, the rapid addition of tasks and/or measured outcome requests is enabled by simply clicking on a time in the calendar 332, typing the name and/or instructions of the Task and/or measured outcome to be reported, and clicking “return.” In another embodiment, the completion status of the non-event task and/or the status and/or change in status of a measured outcome can be tracked via the interface described in element 310 based on input at the point-of-service from the work provider.

If the task and/or measured outcome has additional parameters including but not limited to detailed instructions or recurrence, the user may click “Edit details of the task” in the interface 334 to provide the additional parameters. By way of example and without limitation, see FIG. 3 for an illustrative list of additional parameters that may be specified.

In one embodiment, various views of the calendar may be used by clicking inputs 336 including but not limited to a view of the current day, another day, a week, or a month. As such, a level of calendar granularity convenient to the user may be viewed.

In another embodiment, the calendar is implemented via Ajax, a group of interrelated web development methods used on the client-side to create interactive web applications.

In another embodiment, a set of tasks and/or measured outcomes may be grouped relative to a “work shift,” which is a scheduled work period with a start time and an end time. In another embodiment, when recurrence is set for the work shift, the set of tasks and/or measured outcomes grouped relative to the work shift is similarly made to be recurring.

In another embodiment, a “copy” function is accessible by the user for the work shift by which the user can copy the work shift to another date wherein all of the tasks and/or measured outcomes grouped relative to the original date are copied to the new date along with the start time, end time, and/or other parameters of the work shift. This invention has the benefit that if there are parameters of the new work shift that are similar but not exactly the same as the original work shift, the parameters of the new work shift can retain the parameters of the original without requiring complete data entry of all of the parameters for the new work shift.

By way of example, a work shift from 8 am-12 pm with weekly recurrence on Mondays, Wednesdays and Fridays may have tasks grouped relative to it for “Prepare breakfast”, “Serve breakfast”, and “Provide medication reminder”, and measured outcomes grouped relative to it for “Ambulation” and “Appetite”. In the present example, there may also be the need for a user performing scheduling of one or more workers to schedule a work shift from 8 am-12 pm with weekly recurrence on Thursdays with tasks grouped relative to it for “Prepare breakfast”, “Serve breakfast”, “Provide medication reminder”, and “Play memory game and test” and measured outcomes grouped relative to it for “Ambulation”, “Appetite”, and “Memory”; thus, the work shift on Thursdays is the same as those on Monday-Wednesday-Friday but for the addition of the task, “Play memory game and test” and the request for measurement of a measured outcome, “Memory.” In the present example, in scheduling, the user can copy the work shift on the calendar with the Monday-Wednesday-Friday to a new copied instance on Thursday. In the present example, the user may then set the recurrence of the Thursday work shift to “Weekly”, and then add the additional task for “Play memory game and test” and the measured outcome of “Memory”, thus saving the user performing scheduling the time and effort of having to perform data entry of all of the other tasks and/or measured outcomes grouped relative to the new work shift.

In another embodiment, the administrator of a work management system can create a set of standard measured outcomes which are selectable when generating a work shift. The use of standard measured outcomes, such as “ambulation” or “appetite”, has the advantage of enabling reporting across clients and/or remote workers and/or locations and/or other independent work situations.

In another embodiment, the period of required reporting on the measure outcome is automated wherein a request for the reporting of one or more measured outcomes is automatically added to work shifts on the period specified. By way of example, the administrator may specify a requirement for the reporting on ambulation at least once per week, and as a result the measured outcome “ambulation” is automatically added to at least one work shift per week to be reported by the remote worker. In another embodiment, the automatic adding of said measured outcome is a default configuration which may be overridden by a system user.

In another embodiment, the standard measured outcome may be required to be reported with every work shift.

FIG. 3 is a wireframe diagram that illustrates and example of a shift and task details and measured outcome details portion 340 of a task and measured outcomes information calendar interface of a web-based portal 300 for a work management system which provides tracking and management of work, tracking and measurement of outcomes, a photo storage service which allows the automatic display of photos which are uploaded via said web-based portal to a digital picture frame, the creation and management of non-event tasks, the creation and management of information requests for measured outcomes, the updating of the status of non-event tasks via a computer interface and/or telephony, and the reporting of measured outcomes via a computer interface and/or telephony.

In one embodiment, the shift and task details interface 340 contains an input to assign the work provider 342. For illustrative purposes and by way of example, said input 342 may be to assign a work provider of the type “caregiver” wherein the work management system would be an in-home care work management system. The aforementioned is provided by way of example, and the invention has applicability to any variety of work types and work providers. In another embodiment, the name of the work provider is assigned a default value based on the primary work provider assigned to the particular client, but wherein another work provider may be designated specifically for the task.

In one embodiment, an input 344 enables the input of the title and/or high-level instructions for one or more tasks. In another embodiment, an input allows input of detailed instructions for the task. In another embodiment, an input 348 allows input of the start date, start time and end time of the shift and/or the designation of the shift as an “all day” shift.

In another embodiment, the user may specify recurrence of the shift via a collection of inputs in interface areas 350. The recurrence may be daily with a variety of parameters including but not limited to every day, every “x” number of days, every weekday, etc.; the recurrence may be weekly or every “y” weeks with a variety of parameters including but not limited to every week on one or more specific days of the week, or monthly on every “z” of every month, every “z” day (i.e. Thursday) of every month, etc. Systems for establishing recurrence for an event or meeting are well-known to those skilled in the art; however these systems for creating recurrence have not been applied to the creation of shifts in an online calendar system wherein one or more tasks and/or one or more measured outcome input requests may be specified and grouped relative to the shift wherein recurrence and other properties of the shift may be applied to said tasks and/or measured outcome input requests.

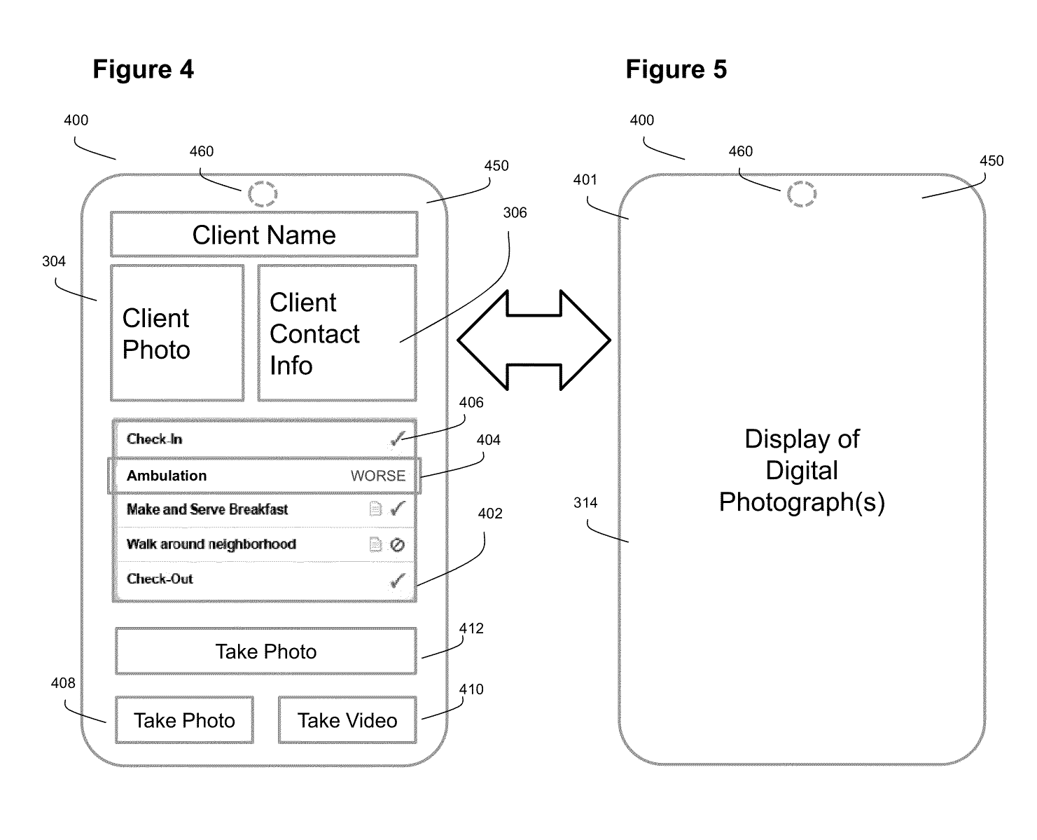

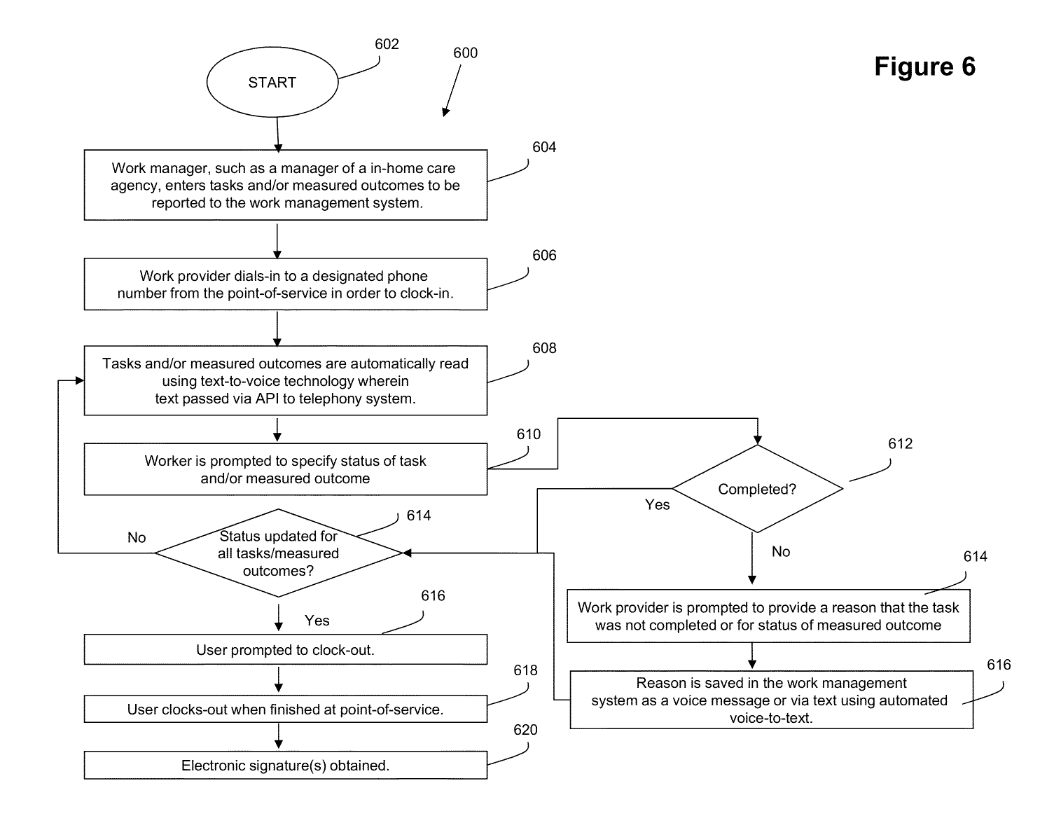

One benefit of embodiments described herein is the ability to specify recurring shifts to which are related non-event tasks and/or measured outcome input requests in the calendar interfaces 330 and 340 wherein the completion status of the non-event tasks and the status and/or change in status may be tracked via a computer interface 310. Another notable benefit is the ability to modify the status of a non-event task and/or the status or change in status of a measured outcome remotely via a Internet-connected computer terminal as shown in exemplary FIGS. 4 and 5, or via telephony as described in FIG. 6.

While the wireframes shown in FIGS. 1, 2 and 3 illustrate examples of particular interface layouts for a work management system, one skilled in the art can anticipate many other specific variations which accomplish the features and benefits of embodiments described herein. Additionally, many of the elements such as 302, 304, 306, 308, 314, 316, 318, 320 and others may be generalized for use of the disclosed embodiments in the context of a social networking website, photo sharing website, or other system.

An example of a specific case of the disclosed work management system is the application of said system for in-home care agencies wherein a multitude of clients receives in-home care and the work provider is a caregiver. The work management systems described herein are examples of particularly valuable approaches to improving the lifestyle and happiness of elderly patients receiving in-home care from a caregiver by enabling the adult children and family of elderly patients to keep track of the provision of care and also to share said photos with the elderly patients. For an in-home care agency which manages care plans for a number of clients and which manages a number of caregivers, the system provides real-time transparency to care and a simple, easy-to-use interface for scheduling care. Moreover, by tracking the status and/or change in status of measured outcomes, it can alert home care administrators, medical personnel, family members, and/or other qualified persons to changes in key conditions in-time for corrective action to be taken.

FIG. 4 and FIG. 5 are wireframe diagrams that illustrate examples of interfaces for caregivers and their patients or clients which are a specific instance of the aforementioned work management system described herein, and which are preferably displayed on an Internet connectable touch screen tablet (ex. Apple iPad) which is used by a caregiver to manage and document care tasks and/or measured outcomes, and which also functions as a digital picture frame when not in use by the caregiver or other users. It may be appreciated by those skilled in the art that features described herein as accruing to the benefit of caregivers could be generalized to work providers of other types and accrue to the benefit of any number of varieties of remote work providers, and similarly the care management features and benefits described can accrue to the benefit of any variety of organizations involved in the management of remote work providers.

Element 400 illustrates an example of a computer system with an interface 450, and shows one embodiment in which said computer system 400 is a touch screen computer tablet in which inputs to the computer system may be made by the user by touching the display screen interface 450, and which includes a built-in digital camera 460 which can take digital photographs that in turn can be stored, manipulated and transmitted by the computer system 400. Such computer systems 400 are well-known and are widely distributed and sold, including by way of example the Apple iPad. Element 400 illustrates the touch screen tablet in a mode in which the interface 450 is configured to be used by a caregiver as part of a work management system to manage and track the completion of care tasks and/or to track the status and/or change in status of measured outcomes.

FIG. 5 illustrates an example of a touch screen tablet computer system such as 400 (FIG. 4) in a mode in which the interface 450 is configured for the display of photos 314 in accordance with the system's 400 additional capability as a digital picture frame.

Element 402 is and example of a list of tasks that are to be completed and/or measured outcomes for which status and/or change in status is to be reported by the caregiver. In one embodiment, the caregiver may click or otherwise input to any individual task and/or measured outcome 404 listed to change its status, by way of example, from “Incomplete” to “Complete.” In another embodiment, the caregiver may click or otherwise input to any individual task and/or measured outcome 404 listed to report its status and/or change in status, by way of example, to “better” or “same” or “worse”. In another embodiment, the caregiver may double-click or otherwise input to any individual task listed 404 to write one or more comments relative to the task and/or measured outcome 404. In one embodiment, each task and/or measured outcome 404 shows a status indicator 406 which indicates the status and/or change in status of the measured outcome 404, and/or an indication 406 that comments have been made about the task and/or measured outcome 404, and/or an indication 406 there are detailed notes about the task and/or measured outcome 404 which may be stored on the work management system, and wherein the absence of such a displayed indicator 406 can also indicate the status of a task and/or measured outcome 404. The user may appreciate that a variety of information may be provided by such an indicator 406 for each task and/or measured outcome 404.

In one embodiment, after the caregiver changes the status of one or more tasks and/or measured outcomes 404 on the task list 402, the changes in the status of the one or more tasks and/or measured outcomes are transmitted to the work management system wherein the updated status of the tasks and/or measured outcomes 404 can be displayed on the list of tasks and/or measured outcomes 310 in the web portal interface illustrated in FIG. 1.

Element 408 illustrates an example of a button that is displayed on the interface 450 which when clicked, in one embodiment, allows the system 400 and camera 460 to take a digital photograph. In one embodiment, the caregiver authenticates his or her identity upon checking-in to a client site and/or prior to viewing tasks and/or measured outcomes and/or changing the status of any tasks and/or measured outcomes, such that said photo may be automatically uploaded to the work management system without subsequent authentication by the caregiver.

In another embodiment, upon clicking the button 408, the caregiver is prompted by software running on the system 400 to confirm with a “yes” or “no” response whether or not the client has given explicit permission to the caregiver for such a photograph to be taken. In another embodiment, the caregiver is prompted via the interface to physically hand the system 400 to the client wherein the client is instructed to authenticate his or her identity with a password or other means in order to enable a photograph to be taken and uploaded to the work management system. The prompts described herein assist with compliance with laws that protect the privacy and confidential health information of clients.

In another embodiment, any photograph which is taken by a system 400 when used in conjunction with the work management system, for example, by clicking the button 408, is restricted such that it is not stored on the system 400 after the caregiver logs out of the work management system, and/or such that said photograph may only be stored permanently if it is transmitted over the Internet to the work management system, and/or stored on said work management system in a secure, remote database, wherein the photo is subsequently deleted from the device 400 after the caregiver logs-out of the present session with the device 400. Thus, photographs taken by the caregiver of the client are restricted in circulation such that the one or more photographs can only be viewed via secure work management interfaces such as illustrated in FIG. 1.

Element 410 illustrates an example of a button which is displayed on the interface 450 which when clicked, in one embodiment, configures the system 400 and camera 460 to take a digital video. The aforementioned functions and features for taking a photo by pressing the button 408 parallel those functions and features for taking a video by pressing the button 410, with the difference that the media file is a digital video file instead of a digital photo file in the case that button 410 is pressed.

In another embodiment, a button 412 triggers means to obtain an electronic signature as means of verifying the completion and/or measured outcome indicators 406 in conjunction with the list of tasks and/or measured outcomes 402. In one embodiment, the electronic signature is obtained by moving a fingertip or stylus over the surface of a touch screen monitor as is well-known to those skilled in the art. In another embodiment, the electronic signature is obtained by the input of a confidential PIN as is well-known to those skilled in the art. In another embodiment, the electronic signature is obtained by the signer recording a voice message which is recorded and stored in association with said list of tasks and/or measured outcomes 402 and completion and/or status and/or change in status indicators 406. In another embodiment, the aforementioned one or more means of obtaining electronic signatures are used in combination to reduce risk of fraud or falsification. Other means of obtaining an electronic signature may be anticipated by those skilled in the art.

FIG. 5 illustrates an example of a touch screen tablet computer system 400 in a mode in which the interface 450 is configured to display one or more photos 314 in accordance with the system's 400 additional capability as a digital picture frame. This mode may be activated according to settings configured by the client, by the caregiver, by a caregiver administrator, or by other users and/or administrators of the integrated work management system, and/or may be preset in software stored on the system 400, or by other means which are understood to those skilled in the art.

FIG. 6 is an exemplary flow diagram that illustrates an example of the use of telephony instead of a touch screen tablet or other remote Internet interface as means to input updates to tasks and/or measured outcomes in the work management system and in which verification information is obtained.

In the aforementioned scenario in which the work management system is used for the management of an in-home care agency, there may be occasions where the problem that the remote terminals by which task information is updated are too expensive to be afforded by the client or by the in-home care agency. Moreover, many clients may not have Internet connectivity in their homes making it difficult and/or expensive to transmit updates of task status to the work management system. This problem, while acute in the in-home care agency industry, is also common to other industries which are dependent on a remote workforce that does not have readily available access to a computer terminal with connection means.

In the late 2000s, an increasing number of telephony services providers emerged such as Twilio (www.twilio.com) and Tropos (www.tropos.com) which provide application programming interfaces (APIs) which are readily usable by those skilled in the art of software programming to build computer-enabled applications which use telephony, including voice recognition, voice-to-text automated transcription, text-to-voice technologies, and text messaging, to serve a variety of purposes.

Embodiments described herein solve this problem via the use of telephony and the new commercially available telephony services. In one embodiment, the aforementioned calendar embodiments may be interfaced with via a telephony system and/or via a computer connected to the Internet wherein the telephony system allows the work provider(s) assigned to a non-event task and/or to the reporting of the status and/or change in status of a measured outcome to update the completion status of the non-event task and/or the status and/or change in status of a measured outcome.

In one embodiment, the computer-enabled system uses automated text-to-voice technology such as that enabled by commercial providers such as Twilio (www.twilio.com) accessible via an application programming interfaced (API) in conjunction with software code known by those skilled in the art to read instructions or other parameters of one or more non-event tasks and/or measured outcomes to be reported upon to the person(s) assigned.

In another embodiment, the computer-enabled system accepts input via telephone from the person(s) assigned by which the person(s) updates the status of the non-event task and/or the status and/or change in status of a measured outcome. By way of example, by pressing the number “one” on the telephone after the computer-enabled system reads the instructions and/or title for the non-event task, the person(s) assigned inputs a status update to mark the task as complete in the work management system. By way of example, by pressing the number “one” on the telephone after the computer-enabled system reads the instructions and/or title for a measured outcome, the person(s) assigned inputs a change in status update as “better” for a measured outcome such as “ambulation” in the work management system, thus reporting that the ambulation of the person receiving care has improved since the last reported period.

In another embodiment, if the person(s) assigned notes an exception to the expected status of the non-event task such as updating the status as “incomplete” and/or the person assigned notes a status or change in status of a measured outcome that meets one or more exception criteria, then the person is prompted to communicate a voice message which is associated with the task and/or group of tasks and/or measured outcome and/or group of measured outcomes which communicates additional information which may include, by way of example, the reason that the non-event task was not completed, and/or the reason associated with the status and/or change in status of a measured outcome.

In another embodiment, a voice message may be stored in a system accessible via the Internet by which the status of one or more tasks (the “checklist”) and/or the status or change in status of one or more measured outcomes may be viewed by one or more users. In another embodiment, a transcript of the voice message is recorded and displayed next to the relevant non-event task or group of tasks and/or measured outcome and/or group of measured outcomes. In another embodiment, a transcript of the voice message may be created via automated computer-enabled voice-to-text translation as enabled by commercial providers such as Twilio accessibly via API in conjunction with other software code, the implementation of which is known to those skilled in the art. By way of example and without limitation, the voice message or its transcription may be displayed in a checklist and/or measured outcome list on a web portal 300 such as illustrated in element 310 of FIG. 1.

Referring now to FIG. 6, an exemplary flow diagram is provided that illustrates a process by which the status of specific task information or measured outcome information is updated via telephony using computer-enabled text-to-voice conversion and in which verification information is obtained. The example process, 600, starting at 602, the work manager enters tasks and/or measured outcomes to be reported upon to the work management system in step 604. In one embodiment, the tasks and/or measured outcomes are entered to the work management system via a calendar interface 330 in a web portal 300 with the additional features of being able to specify recurrence via inputs 350 and 352. In another embodiment, the tasks and/or measured outcomes are entered group relative to a work shift wherein the work shift may be made to be recurring and/or the tasks and/or measured outcomes inherit other parameters of the work shift such as the remote worker(s) assigned. In another embodiment, the tasks and/or measured outcomes are entered relative to a specific client and the client contact information 306 includes the location at which the service is to be provided and the telephone number of the client.

In step 606, the work provider dials-in to a designated phone number from the point-of-service in order to clock-in. In one embodiment, the work management system compares the caller ID of the telephone from which the work provider is calling to the contact information 306 of the client to verify that the work provider is at the proper location.

In step 608, tasks and/or measured outcomes to be reported are read to the work provider sequentially using text-to-voice technology by passing text information related to the task and/or measured outcome to be reported such as the desired start time, the desired end time, the title or high-level instructions, and/or detailed instructions to a telephony service provider from the work management system via API. Telephony service providers such as Twilio (www.twilio.com) and related APIs are well-known to those skilled in the art. Thus, the work provider is prompted with the task(s) to be performed and/or the measured outcomes on which they should report.

In one embodiment, some or all of the tasks to be performed and/or measured outcomes to be reported within a specific period of time or shift may be automatically read to the work provider in the first reading after the clock-in step 608 wherein there are no interruptions for prompts requesting completion status so that the work provider can be informed of the tasks to be performed and/or measured outcomes to be reported upon, and wherein in subsequent readings, following the reading of each task and/or measured outcome there is a prompt in step 610 to the work provider to update the status of each individual task and/or the status and/or change in status of each individual measured outcome.

In another embodiment, there is no such initial “read through” of tasks. Instead, after clock-in in step 606, the tasks and/or measured outcomes to be reported upon are read one at a time in step 608 and after each task and/or measured outcome to be reported upon is read, the work provider is prompted to answer whether or not the task has been completed, and/or to report on the status and/or change of status of a measured outcome, in step 610. The work provider can respond to the prompts using means well-known to those skilled in the art such as by pressing a digit on the phone or responding verbally. The commercially available telephony service interprets the input from the work provider in step 612 per rules specified in software code as is known to those skilled in the art, and if the completion status of a task has been updated and/or if the status and/or change in status of a measured outcome has been updated, in step 614, a determination is made as to whether or not there are additional tasks and/or measured outcomes for which status has not been updated.

If there are additional tasks and/or measured outcomes for which status must be updated, then the process repeats in step 608 as the next task and/or measured outcome is read. If status has been updated for all tasks and/or measured outcomes as determined in step 614, then the process proceeds to step 616 wherein the work provider is prompted to clock-out. If the work provider has no further work to do at the point-of-service, then in step 618 the work provider clocks-out.

Returning now to the task and measured outcome status update process, in step 612, if the work provider responds that the task has not been completed and/or the status and/or change in status of a measured outcome meets one or more exception criteria, in one embodiment, in step 614 the work provider is prompted to record a reason that the task was not completed and/or the reason associated with the status and/or change in status of a measured outcome. In another embodiment, in step 616, the reason provided in 614 is saved in the work management system as a voice message file via means well-known to those skilled in the art and enabled by telephony service providers such as Twilio, or is automatically transcribed to text using voice-to-text technologies provided by telephony service providers such as Twilio. After recording the reason, the process proceeds to step 614 wherein it is determined whether or not the status has been updated for all tasks and/or measured outcomes.

In another embodiment, the recording of the reason, whether in a voice message or in transcription, is accessible via web portal 300, preferably in a computer interface 310.

In one embodiment, the work management system compares the caller ID of the telephone from which the work provider is calling to the contact information 306 of the client to verify that the work provider is at the proper location during the point in time at which status for each task is updated. In another embodiment, the work provider can hang up the phone at any point and resume the process at the step at which the work provider last left-off by calling the telephony service phone number again.

In one embodiment, as the status of tasks and/or measured outcomes is updated via the telephony system, the updated status can be viewed via the web portal 300 via interface 310 as shown and described relative to FIG. 3. In another embodiment, alerts are provided via the web portal 300, via text messaging, via outbound calling as enabled via the telephony service, or other approaches known to those skilled in the art to the work manager, the work provider, persons associated with the client, or other stakeholders in the event that a clock-in is missed or if a task is not completed, completed, and/or a task and/or measured outcome is marked with a status or change in status which is designated to trigger an alert. Thus, the telephony service in the work management system allows a variety of stakeholders to have real-time visibility of highly specific tasks and/or measured outcomes without requiring a costly remote computer terminal such as, by way of example, a mobile computing tablet 400.

In another embodiment, the aforementioned telephony-accessible calendar system provides the capability of obtaining an electronic signature from one or more persons at the end of a work shift. In step 620, in one embodiment, said system uses text to voice technology to read information about the shift to said one or more persons, wherein information may include but is not limited to the clock-in time and the non-event task completion status, and the said one or more persons is prompted to provide an electronic signature to verify the information about the shift. In one embodiment, the electronic signature is provided via a confidential personal identification number (“PIN”) that is known only to the person asked to provide verification and preferably in which the PIN is provided via the keypad of a telephone. In another embodiment, the electronic signature is provided via a voice recording that the signer leaves via a telephone, preferably after listening to the aforementioned information about the shift. In another embodiment, the PIN is used in conjunction with the voice recording to comprise a fraud- and falsification-resistant electronic signature.

In another embodiment, an indicator of the electronic signature is provided in an electronic log accessible via a web-based portal 300 for a work management system, preferably in association with related information about the shift 310. In another embodiment, a link to a copy of the voice-recorded signature is provided in an electronic log accessible via a web-based portal 300 for a work management system in association with related information about the shift 310.

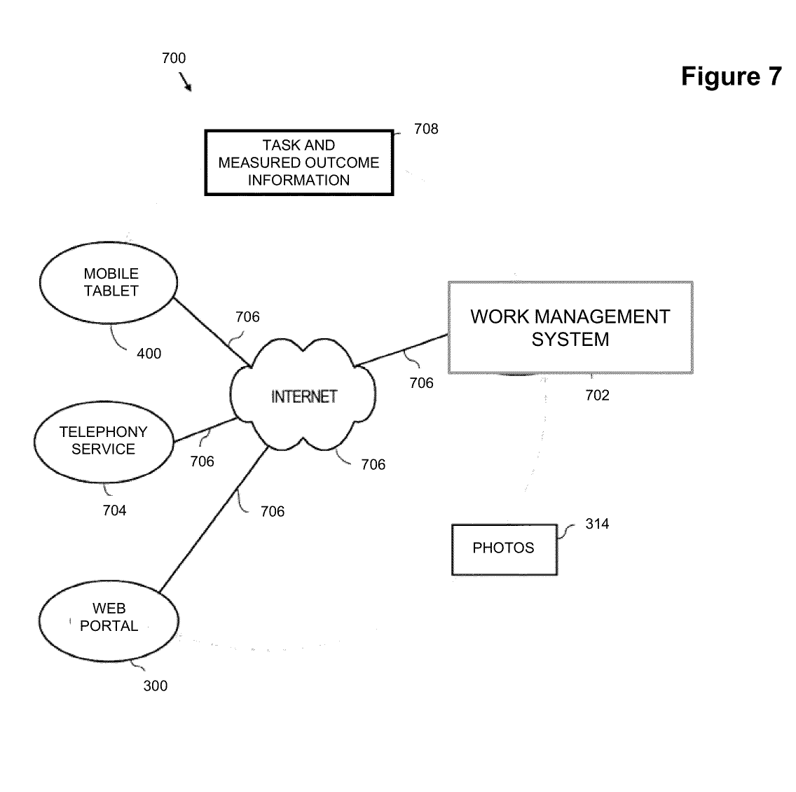

FIG. 7 is a block diagram 700 that illustrates and example of the communication of entities via Internet connections 706 for the transmission of a variety of information, including but not limited to digital photographs 314 for display on a digital picture frame 400 and/or work management system 702 accessible via a web portal 300, task and/or measured outcome information 708, possibly including but not limited to updates to the completion status, telephony service 704 by which task and/or measured outcome information 708 and other information may be sent and received in order to enable updates to the work management system 702 accessible via the web portal 300, and the mobile tablet 400 also functioning, in one embodiment, as a digital picture frame as well as additional means by which task and/or measured outcome information 708 and other information may be sent and received to and from the work management system 702 accessible via the web portal 300.

In one embodiment, via a web portal 300, task and/or measured outcome information 708 may be input to the work management system 702, to be provided to a work provider via a mobile tablet 400 or via telephony service 704. The work management system 702 comprises a database, computer-enabled means to interpret software code, and computer-enabled means to communicate between various devices and interfaces accessing the work management system 702 including the mobile tablet 400, the telephony service 704, and the web portal 300. In another embodiment, the work management system includes computer and software-enabled means for displaying photos 314 and other media on the mobile tablet 400 when the mobile tablet 400 is not in use by a work provider to inform the completion of assigned tasks, to update task status, or to otherwise inform and manage the work plan.

Considering now a specific application by way of example and without limitation to the aforementioned, an in-home care agency managing a multitude of patients or clients and a multitude of caregivers realizes a great number of benefits via usage of the aforementioned embodiments. Today, many in-home care agencies use paper care journals at the point-of-care to manage care and record updates as to the completion of tasks. Unfortunately, the use of paper care journals makes it impossible for in-home care agency managers and family and adult children of elderly clients to closely observe the care provided.

The mobile tablet interfaces eliminate the need for paper care journals and enable real-time visibility to the point-of-care for in-home care agency managers and for the family of patients and clients. This significantly reduces costs and improves the quality of care.

For situations in which a mobile interface cannot be afforded, the telephony service provides a low-cost means leveraging patients and/or client's existing phone systems to achieve the same benefits with a level of granular visibility to the care provided, tasks completed, and the status and/or change in status of measured outcomes that did not previously exist.

Additionally, the work management system disclosed provides an easy-to-use and intuitive means of scheduling a care plan via a calendar interface. Today, care plans and task scheduling are typically managed via paper care journals for in-home care agencies. When care plans are managed electronically, they are often managed with highly-detailed form templates that lack the dimension of scheduling of specific tasks at specific times and of scheduling one or more tasks relative to a shift wherein the tasks inherit one or more parameters of the shift, including by way of example, the shift recurrence or the worker is assigned. When a calendar is used, no greater granularity than a work shift is provided; current solutions lack task-specific granularity.

The task input calendar interface disclosed provides very critical improvements to these systems by providing a robust, highly flexible means of scheduling very detailed care plans with associated tasks and measured outcomes to be reported with each shift. Because of this critical enabling feature, it follows that the individual tasks can be output to a mobile tablet, a Internet connectable computer, and/or telephony services as described, and the status of tasks and/or measured outcomes can also be updated via these channels. As such, it provides unprecedented visibility to the point-of-care allows new and beneficial features including but not limited to alerts if tasks that have been scheduled as part of the care plan are missed, and/or if the status or change in status to measured outcomes requires attention by qualified persons.

As discussed herein, the embodiments may involve a number of functions to be performed by a computer processor, such as a microprocessor. The microprocessor may be a specialized or dedicated microprocessor that is configured to perform particular tasks according to the embodiments described herein, by executing machine-readable software code that defines the particular tasks embodied by the embodiments and examples described herein. The microprocessor may also be configured to operate and communicate with other devices such as direct memory access modules, memory storage devices, Internet-related hardware, and other devices that relate to the transmission of data in accordance with the embodiments and examples described herein. The software code may be configured using software formats such as Java, C++, XML (Extensible Mark-up Language) and other languages that may be used to define functions that relate to operations of devices required to carry out the functional operations related to the embodiments and examples described herein. The code may be written in different forms and styles, many of which are known to those skilled in the art. Different code formats, code configurations, styles and forms of software programs and other means of configuring code to define the operations of a microprocessor in accordance with the embodiments and examples described herein will not depart from the spirit and scope of the embodiments and examples described herein.

Within the different types of devices, such as laptop or desktop computers, hand held devices with processors or processing logic, and also possibly computer servers or other devices that utilize the embodiments and examples described herein, there exist different types of memory devices for storing and retrieving information while performing functions according to the embodiments and examples described herein. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the embodiments and examples described herein when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the embodiments and examples described herein as described herein enable the physical transformation of these memory devices. Accordingly, the embodiments and examples described herein as described herein is directed to novel and useful systems and methods that, in one or more embodiments, are able to transform the memory device into a different state. The embodiments and examples described herein is not limited to any particular type of memory device, or any commonly used protocol for storing and retrieving information to and from these memory devices, respectively.

Embodiments of the systems and methods described herein facilitate the management of home care provider scheduling. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments and examples of the invention have been described and illustrated, the invention is not to be limited to the specific forms or arrangements of parts so described and illustrated. The scope of the invention is to be defined by the claims appended hereto and their equivalents.

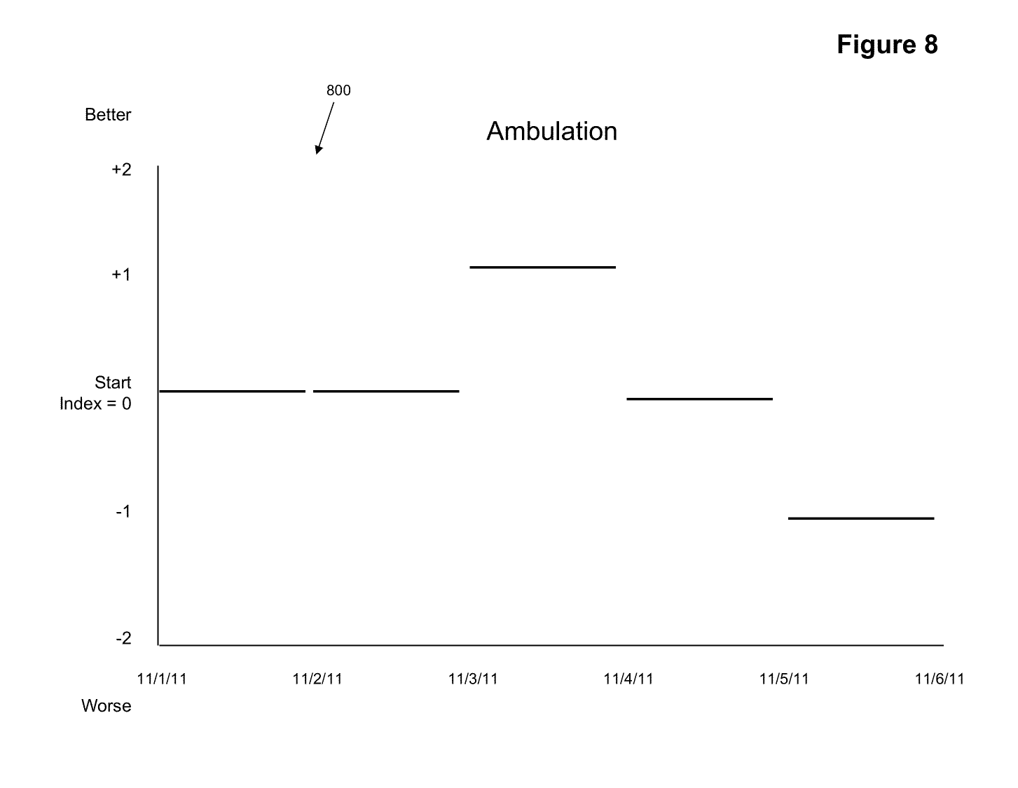

FIG. 8 is an example of an illustrative report of measured outcome data. One skilled in the art may use any manner of reports to convey measured outcome data, and FIG. 8 is provided by way of example and without limitation to the variety of reports that may be used.

In the example of FIG. 8, an index is provided on the y-axis wherein a measured outcome reported as “better” than the prior report is recorded as +1 on the index, a measured outcome reported as “same” as the prior report is recorded as +0 on the index, and a measured outcome reported as “worse” than the prior report is recorded as a −1 on the index. The embodiment has the benefit of providing a cumulative reading of independent changes in the status of a measured outcomes. Thus, an overall change in status may be estimated.

In another embodiment, the remote worker may report changes to status of the measured outcome on a scale, by way of example, from −3 to +3. In this way, more granularity of change in status may be recorded thus providing greater inference from any given status report and from cumulative changes.

In one embodiment, one or more criteria may determine when the status of a measured outcome, the change in status of a measured outcome, and/or the cumulative change in status of a measured outcome generates an alert. By way of example, in the present report, if the cumulative change in status is <=2, then an email and text message alert may be sent to the manager of a remote worker recording the change in status of the measured outcome. In another embodiment, the one or more criteria may be specified as cumulative change within a specified time period.

In another embodiment, the one or more criteria determines when the remote worker is prompted to provide further information on the measured outcome being measured. In another embodiment, when the one or more criteria is met and when the remote worker is reporting status and/or change of status of the measured outcome via telephony, then the prompt is provided via telephony interactive voice response as is known to those skilled in the art wherein the computer-enabled system reads instructions to the remote worker to leave a voice recording to explain the status and/or change in status of the measured outcome. In another embodiment, the voice recording is displayed in a work management portal 300 where it may be reviewed by qualified users such as a care manager, an administrator, medical personnel, family members, and/or other qualified users.

In another embodiment, when the remote worker is reporting status and/or change of status of the measured outcome via a computer terminal, then the prompt is provided via said computer terminal to input additional information to explain the status and/or change in status of the measured outcome.

Although specific embodiments of the invention have been described and illustrated, the invention is not to be limited to the specific forms or arrangements of parts so described and illustrated. The scope of the invention is to be defined by the claims appended hereto, future submitted claims, and any equivalents

What is claimed is:

1. A telephony accessible calendar system for use in a home care scheduling system for scheduling multiple daily work shifts of home care providers, comprising:
a scheduling system configured to organize work shifts of remote operating home care workers and also configured to maintain entries of measured outcome information requests.

2. A system according to claim 1, wherein the entries can be made recurring on a daily, weekly, or monthly basis according to predetermined parameters.

3. A system according to claim 2, wherein the predetermined parameters are set by the user.

4. A system according to claim 1, wherein the scheduling system is further configured to maintain non-event tasks, wherein the non-event tasks and/or measured outcome information requests may be grouped relative to a recurring shift.

5. A system according to claim 4, wherein the user may copy a work shift from one date to another date, wherein copying the work shift copies the non-event tasks and/or measured outcome information requests grouped with the original work shift.

6. A system according to claim 1, wherein the scheduling system is further configured to maintain non-event tasks, wherein the non-event task and/or measured outcome information request may be assigned to one or more persons or groups of persons for completion.

7. A system according to claim 1, wherein the scheduling system is further configured to maintain non-event tasks and/or measured outcome information requests, wherein the completion status of one or more non-event tasks and/or the status and/or change in status of a measured outcome may be updated via a computer-enabled terminal connected to the Internet and/or telephony system.

8. A system according to claim 1, wherein the scheduling system is further configured to maintain non-event tasks and/or measured outcome information requests, wherein one or more users at remote locations may view the updated completion status of the one or more non-event tasks and/or the status and/or change in status of a measured outcome.

9. A system according to claim 1, wherein the scheduling system is further configured to maintain non-event tasks, wherein an exception state may be noted relative to the completion of one or more non-event tasks and a reason provided by the assigned person(s).

10. A system according to claim 1, wherein the scheduling system is further configured to maintain non-event tasks, wherein the completion status of the one or more non-event tasks is managed by a checklist interface.

11. A system according to claim 1, wherein the scheduling system is further configured to maintain non-event tasks, wherein the status and/or change in status information of one or more measured outcomes is viewable via a computer interface.

12. A system according to claim 1, wherein an exception state may be noted relative to the status and/or change in status of a measured outcome.

13. A system according to claim 1, wherein an exception state may be noted relative to the status and/or change in status of a measured outcome, wherein the parameters defining the exception state are set by a user.

14. A system according to claim 1, wherein an exception state may be noted relative to the status and/or change in status of a measured outcome, wherein an exception state may be noted relative to the status and/or change in status of a measured outcome and a reason provided by the assigned person(s).

15. A system according to claim 1, wherein an exception state may be noted relative to the status and/or change in status of a measured outcome, wherein a prompt is provided to the home care worker in the event of the exception state to provide a reason related to the status and/or change in status of a measured outcome.

16. A system according to claim 15, wherein the prompt is provided via a text-to-voice telephony system.

17. A system according to claim 12, wherein the exception state is defined based on cumulative changes in status of a measured outcome.
